(19) United States
(12) Patent Application Publication
(10) Pub. No.: US 2021/0254728 A1
(43) Pub. Date: Aug. 19, 2021

(54) BALL VALVE WITH INTERNAL SEAL ARRANGEMENT, IN PARTICULAR FOR USE IN MOTOR VEHICLE REFRIGERANT CIRCUITS

(71) Applicant: Hanon Systems, Daejeon (KR)

(72) Inventor: Corinne Le Pellec, Pulheim (DE)

(21) Appl. No.: 17/241,258

(22) Filed: Apr. 27, 2021

Related U.S. Application Data
(63) Continuation of application No. 14/361,905, filed on May 30, 2014.

(30) Foreign Application Priority Data
Nov. 30, 2011 (DE) 102011055892.6
Nov. 27, 2012 (DE) 102012111468.4

(51) Int. Cl. F16K 5/06

(52) U.S. Cl. CPC F16K 5/0689; F16K 5/0642

(57) ABSTRACT

A ball valve with internal sealing arrangement for use in motor vehicle refrigerant circuits The ball valve includes an actuator, a shaft with shaft bearing, a ball with a ball passage conduit, and a valve housing with refrigerant connections. The ball is supported in the valve housing in a floating manner and is arranged between two ball seal seats. A first ball seal seat is received by the valve housing and is supported in a sealing manner against the valve housing by a first sealing seat seal. A second ball seal seat is received by a closure part in the opposing valve housing and is supported in a sealing manner against the valve housing by a second sealing seat seal. A first expansion notch and a second expansion notch extend from the ball passage conduit toward a chamber formed in the valve housing.

### CROSS-REFERENCE TO RELATED PATENT APPLICATIONS

This patent application is a continuation patent application of co-pending U.S. patent application Ser. No. 14/361,905 which is a United States national phase application based on PCT/EP2012/074157 filed Nov. 30, 2012 which claims the benefit of German Patent Application No. DE 10 2011 055 892.6 filed Nov. 30, 2011 and German Patent Application No. DE 10 2012 111 468.4 filed Nov. 27, 2012. The entire disclosures of the above applications are hereby incorporated herein by reference.

### FIELD

The invention relates to a ball valve, in particular for use in motor vehicle refrigerant circuits.

### BACKGROUND

Ball valves comprise an actuator that drives a shaft supported in a shaft bearing that transfers the rotary movement to the valve element, that is formed by a ball with a ball passage conduit. The components are supported in a valve housing and ball valves are considered to be robust and economical and are used for many applications.

In modern refrigerant systems for motor vehicle air conditioning systems new functionalities are integrated that are associated with high requirements placed on the individual components of the refrigerant system such as, for example, a heat pump. To this end it is necessary to integrate novel valves and to provide the components used, in particular the expansion parts, with expanded functionalities. This requires, among other things, that the valves can be used bidirectionally relative to the flow of refrigerant through the valve and that the systems also satisfy the particularly high sealing requirement for refrigerant systems in mobile applications.

In the past, components suitable for practice were hardly available in the prior art and therefore there is a need to modify proven components and to adapt them to the new tasks.

For example, ball valves according to DE 24 30 409 A1 are known in the prior art that are especially adapted as structural elements for fluid line arrangements in order to satisfy the requirements relative to tightness and ease of assembly as well as to optimizing the number of individual components.

In general, sealing problems are known in ball valves as regards the so-called internal tightness, that refers to the flowthrough of the fluid to be regulated by the valve. In contrast thereto, the external tightness concerns the tightness of the valve relative to the surroundings of the valve, since the moving shaft for the positioning movement of the valve body must be sealed against the surroundings in order to avoid an exiting of the fluid to be regulated via the shaft, which is supported in such a manner that it can move in a rotary manner.

Other requirements are placed on the valves in refrigerant systems since the components are also loaded with very high differences of temperature and of pressure. In particular, the seals must be adapted in this regard to very high requirements caused by the occurring thermal tensions and material shrinkages and expansions. Furthermore, the problems are further intensified in that especially high requirements are placed on refrigerant-carrying systems when used in mobile applications such as, for example, motor vehicles. This is also expressed in the fact that a very long service life and the ability of the components to function in mobile applications is expected in order to minimize the escape of refrigerant into the surroundings.

Therefore, the invention has the problem of creating a valve that is very tight in regard to the internal sealing of a valve that is suitable for being used in refrigerant systems for motor vehicle air-conditioning systems.

### SUMMARY

The problem is solved by the features of a ball valve as disclosed herein.

This problem is solved by the invention of the ball valve with an internal sealing arrangement since the latter is especially suited for being used in motor vehicle refrigerant circuits.

The ball valve consists substantially of an actuator, a shaft with shaft bearing, a ball with a ball passage conduit and of a valve housing with fluid line connections and in particular refrigerant connections. The particularity of the ball valve of the invention consists in that the ball is supported in a floating manner in the valve housing and that the ball is arranged to this end between two ball sealing seats. A ball sealing seat is positively received by the valve housing and sealingly supported against it by a sealing seat seal. Furthermore, a second ball sealing seat is arranged in an opposing manner in the valve housing and is positively received by a closure part and sealingly supported against the latter by a sealing seat seal. The closure part is sealingly supported opposite the valve housing by a closure part seal.

According to an advantageous embodiment of the invention the ball sealing seats are constructed as hollow cylindrical rings whose insides have at least partially a ball sealing surface constructed so as to correspond to the ball. The ball sealing surface is constructed as a ball zone. The part of the ball surface that is cut out from the ball surface by two parallel planes is designated as ball zone. In the “closed” position of the ball the ball passage conduit is arranged transversely to the direction of flow through the valve and the ball sealing surface rests on the ball in such a manner that no fluid can pass through the surfaces lying on one another in a corresponding manner between the ball and the ball sealing surface of the ball sealing seat.

The sealing seat seals are preferably arranged in the axial direction between the ball sealing seats and the valve housing or the closure part. Therefore, the internal tightness of the ball valve can be directly regulated by a contact force acting axially in the direction of flowthrough. Depending on the effective contact force and deformability of the material as well as the thickness of the sealing seat seal, the ball is shiftably supported in the axial direction within these limits, which is designated as a floating support.

According to another embodiment of the invention, in distinction to the axial arrangement of sealing elements, the closure part seal is arranged in the radial direction between the valve housing and the closure part. As a consequence, the radially arranged seal counteracts an axial flowthrough of refrigerant between the closure part and the valve housing.

According to another embodiment this is solved in that the closure part is arranged by an outer threading in a corresponding inner threading of the valve housing.

In order to make possible the mobility of the ball in the axial direction, according to an advantageous embodiment of the invention a nose is arranged on the shaft that transfers the rotary positioning motion of the shaft (3) via an engagement notch in the ball onto the latter. The shape of the nose and/or the formation of the engagement notch is/are designed in such a manner that during the engagement of the nose in a vertical position of it a play is present for the direction of flowthrough.

Another embodiment of the ball valve furthermore results from the fact that the ball additionally comprises, in addition to the ball passage conduit, an expansion notch that extends away from the ball passage conduit toward the chamber on the outside of the ball and by which the flowthrough cross section of the valve can be reduced for the expansion of the fluid flowing through the ball valve.

The cross section of the expansion notch preferably decreases away from the ball passage conduit so that at first the flowthrough cross section of the valve is limited to the cross section of the expansion notch by the rotation of the ball from the “closed” position to the “open” position, which represents the position with the smallest flowthrough cross section in the valve. The refrigerant flows in this position from the refrigerant connection via the expansion notch in the surface of the ball to the chamber inside the valve housing, enters into the ball passage conduit and arrives via the chamber on the opposite side and the expansion notch at the refrigerant connection. The expansion notch limits the free flowthrough cross section of the valve along an associated positioning movement and there is therefore the possibility of adjusting very low flowthrough rates and the expansion of the fluid flowing through the ball valve. This brings it about that the flowthrough characteristic of a ball valve is advantageously changed as a function of the bevel of the shaft to small and very small flowthrough rates.

In contrast to the above, the flowthrough characteristic of ball valves in accordance with the prior art is characterized in that conditioned by the manner of the construction of the ball valve a fine adjustment of the flowthrough rate is only poorly possible on account of too great an effect of the bevel of the shaft on the flowthrough rate. The ball passage conduit in the valve body, that is, the ball, is already so greatly opened already at a few degrees of bevel that there are hardly any possibilities for a fine adjustment of low flowthrough rates. Now, the expansion notch allows the fine adjustment of the flowthrough rates through the ball valve in a range of the bevel respectively of the switching position of the ball of between 0° and 70°. It is therefore achieved in an especially advantageous manner that a ball valve with the known robustness of the design of this constructive solution of the refining of the adjustability of the flowthrough rate can be used as an expansion valve for refrigerant systems.

The expansion notch is especially preferably designed to correspond to a ball bevel of 65° to 70°.

The conception of the invention resides primarily in the fact that the internal seal of the ball valve is realized by a floating support of the ball between two ball seal seats, wherein the ball seal seats are, for their part, supported in a sealing manner by sealing seat seals.

The floating support of the ball makes possible an economical production of an internal sealing construction for the ball, that can be readily mounted in an advantageous manner and also be readily exchanged for repairs.

The valve type is suited by the modification of the actuator and of the ball geometry for creating two/two valves, three/two valves and four/two valves.

### DESCRIPTION OF THE DRAWINGS

Other details, features and advantages of embodiments of the invention result from the following description of exemplary embodiments with reference made to the associated drawings. In the drawings:

FIG. 1 shows a cross section of a ball valve;

FIG. 2 shows a cross section through the valve housing of a ball valve and shows the valve body in 100% passage position;

FIG. 3 shows a cross section of the ball valve in the expansion position;

FIG. 4 shows an exploded view of a ball valve with its essential components.

### DETAILED DESCRIPTION OF THE EMBODIMENTS

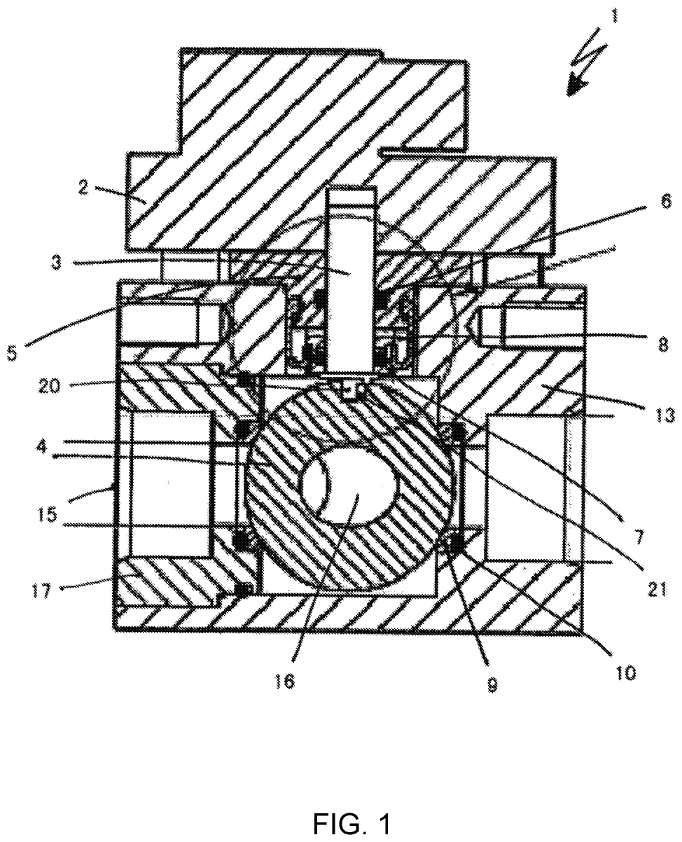

FIG. 1 shows a ball valve 1 in cross section with its essential components. The ball valve 1 comprises an actuator 2 that rotates a shaft 3 in accordance with a desired degree of flowthrough of the valve. The shaft 3 is connected by a nose 20 to the ball 4, wherein the nose 20 engages in an engagement notch 21 in the ball 4. The engagement notch 21 is dimensioned in such a manner in its width that the nose 20 has play in the notch, as result of which the ball 4 is designed so that it can be shiftably arranged on the axis of the direction of flow within certain limits, which is an advantageous design for the floating support of the ball 4. The ball passage conduit 16 is constructed in the ball 4 through which conduit the fluid flows from the valve inlet to the valve outlet in the open valve position of the ball valve 1. In the shown embodiment of the ball valve 1 for refrigerant systems the inlet and outlet of the valve are designed as refrigerant connection 15.

The shaft 3 is supported in a shaft bearing 5 in such a manner that it can rotate about its axis. The shaft bearing 5 comprises an external shaft seal 6 and an internal shaft seal 7 between which a fluid shaft seal 8 is constructed. The sealing arrangement of external shaft seal 6, internal shaft seal 7 and intermediate fluid shaft seal 8 has the task of preventing the escape of liquid flowing through the ball valve 1 via the play of the shaft 3 in the shaft bearing 5. This sealing system is also designated as an external double sealing system and is decisive for the external leakage rate of the ball valve 1.

The ball 4 is supported regarding the internal seal in or between two ball seal seats 9, wherein the ball seal seat 9 is supported in a floating manner in the valve housing 13 and the closure part 17 is supported in a floating manner via a sealing seat ring 10 in the axial direction. The term axial direction denotes, unless nothing else is determined, the longitudinal axis of the valve body 13, along which the flowthrough of the ball valve 1 takes place.

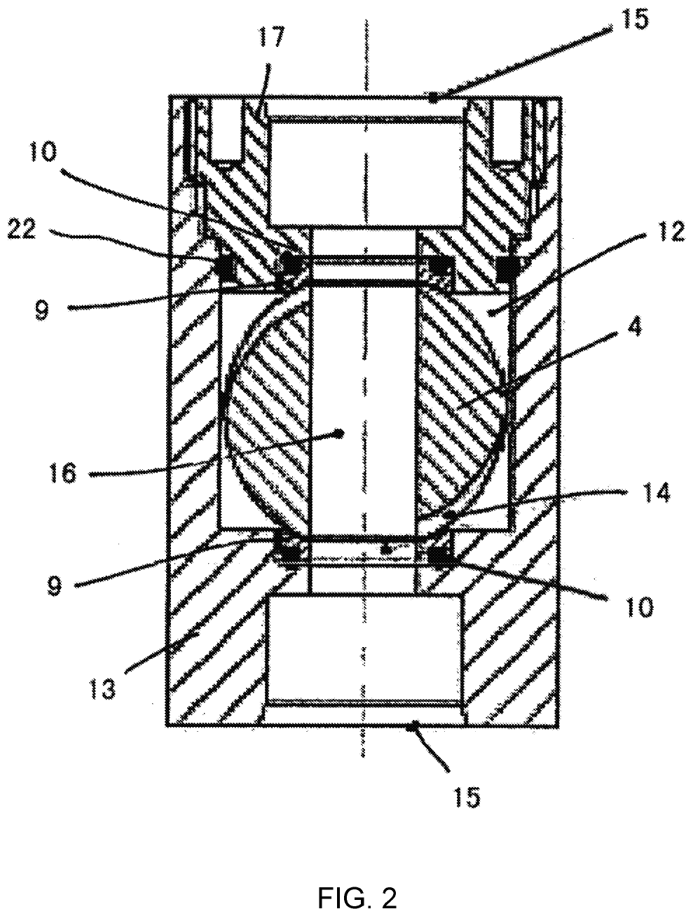

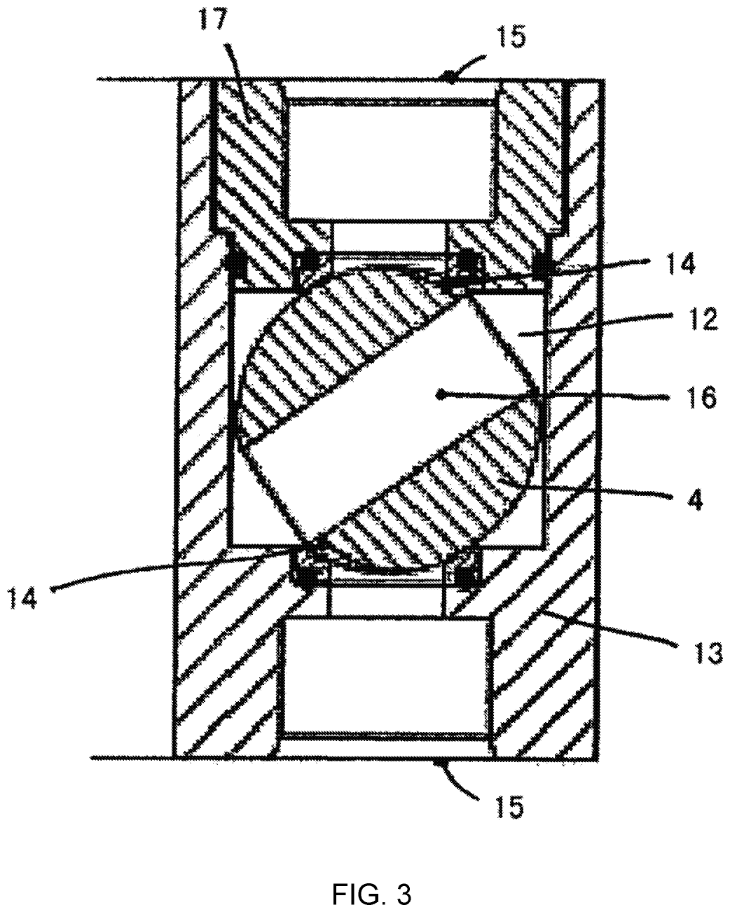

FIG. 2 and FIG. 3 show the essential components of the valve with the refrigerant connections 15, the valve housing 13 and the seal seats 9 with associated sealing seat seals 10 in different operating situations or switching positions.

FIG. 2 shows the valve housing 13 of the ball valve in section and the top view onto the fluid passage. The refrigerant connections 15 on both sides of the passage can be a fluid input as well as a fluid output and clarify the bidirectional possibility of flowthrough for the fluid. The valve housing 13 has a recess in the form of the chamber 12 in which the ball 4 is arranged. The ball 4 comprises the ball passage conduit 16 that, given the appropriate switching according to FIG. 2, shows the maximal flowthrough cross section through the valve. Ball 4 is tightly held on both sides by a ball seal seat 9 and the ball seal seats are sealed and supported against the valve housing 13 and against the closure part 17 in each case by a sealing ring 10. The sealing rings 10 are loaded in the axial direction, which means that the sealing force acts in the axial direction and the sealing rings 10 are pressed or pre-tensioned between two radial circular ring surfaces on the front sides of the ball seal seats 9. Therefore, the sealing takes place in the axial and radial direction. A ball sealing seat 9 guided in the axial direction, is positively received by the valve housing 13 and the opposite ball sealing seat 9, guided in the axial direction, is positively received by the closure part 17.

The hollow cylindrical closing part 17 is screwed in by an external threading into the valve housing 13 with a corresponding internal threading and can therefore be finely positioned axially as a function of the threading pitch. Sealing force is applied on the sealing seat seals 10 arranged on the front sides of the ball seal seats 9 by screwing in the closure part 17. The closure part 17 comprises a closure part seal 22 on its outer circumference that seals the closing part 17 against the valve housing 13. The arrangement of the closure part seal 22 on the circumference of the closure part 17 makes possible the axial shifting of the closure part 17 in the valve housing 13 with the simultaneous sealing of the parts against one another.

An expansion notch 14 is formed in the ball 4 on the surface of the ball which is formed tapering from the ball passage conduit 16 in the rotational plane of the ball along the circumference.

In FIG. 3, the ball 4 is rotated in such a manner in the chamber 12 that the flowthrough cross section of the valve is reduced to a limited range of the expansion notch 14, also designated as the flowthrough notch. As can be recognized, the chamber 12 has the fluid system pressure of the fluid flowing through the valve.

The refrigerant in the valve position according to FIG. 3 therefore flows from a refrigerant connection 15 via the expansion notch 14 into the chamber 12, through the ball passage conduit 16 to the opposite chamber 12 and to the expansion notch 14 on the other end of the conduit 16 and through the latter to the outlet of the refrigerant connection 15 on the other side of the valve.

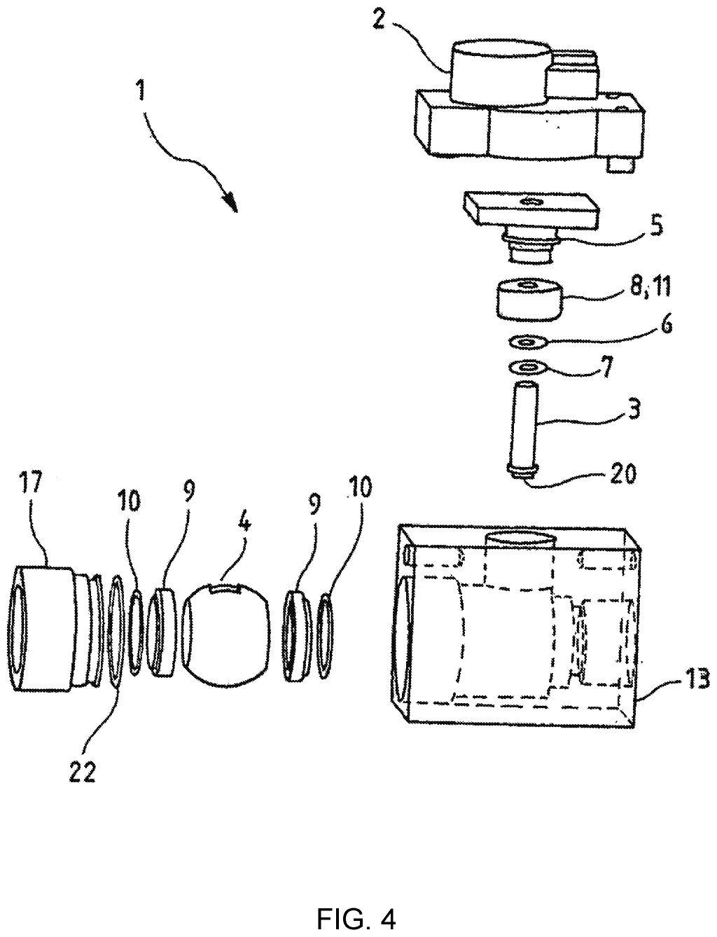

FIG. 4 shows a ball valve 1 in an exploded view. The main components, the actuator 2, the valve housing 13, the shaft 3 with the nose 20 and the ball 4 are supplemented by the components of the bearing for the shaft 3 with the shaft bearing 5, by the associated external and internal shaft seals 6 and 7 as well as the fluid shaft seal 8 with the membrane 11. The ball 4 is supported in the embodiment shown by opposingly placed ball sealing seats 9 that for their part are supported in a sealing manner by a sealing seat seal 10 opposite the valve housing 13 or on the other side opposite the closure part 17. The closure part seal 22 completes the shown components of the ball valve 1.

### LIST OF REFERENCE NUMERALS

1 ball valve
2 actuator
3 shaft
4 ball
5 shaft bearing
6 external shaft seal
7 internal shaft seal
8 fluid shaft seal
9 ball seal seat
10 sealing seat seal
11 membrane
12 chamber
13 valve housing
14 expansion notch
15 refrigerant connection
16 ball passage conduit
17 closure part
20 nose
21 engagement notch
22 closure part seal

What is claimed is:

1. A ball valve with internal sealing arrangement, for use in motor vehicle refrigerant circuits, comprising:
an actuator;
a shaft with a shaft bearing;
a ball with a ball passage conduit; and
a valve housing with refrigerant connections, wherein the ball is supported in the valve housing in a floating manner and the ball is arranged between two ball seal seats, wherein a first one of the ball seal seats is received by the valve housing and is supported in a sealing manner against the valve housing by a first sealing seat seal, and a second one of the ball seal seats is received by a closure part in the valve housing and is supported in a sealing manner against the valve housing by a second sealing seat seal, wherein a first expansion notch and a second expansion notch extend from the ball passage conduit toward a chamber formed in the valve housing, wherein only the ball is housed in the chamber and the first one of the ball seal seats and the second one of the ball seal seats and the first sealing seat seal and the second sealing seat seal are disposed outside the chamber.

2. The ball valve according to claim 1, wherein the first one of the ball seal seats and the second one of the ball seal seats are constructed as hollow cylindrical rings whose inside has a ball seal surface corresponding to the ball, wherein the ball seal surface is constructed as a ball zone.

3. The ball valve according to claim 1, characterized in that the first sealing seat seal and the second sealing seat seal are arranged in the axial direction between the first one of the ball seal seats and the second one of the ball seal seats and the valve housing or the closure part.

4. The ball valve according to claim 1, wherein a closure part seal is arranged in a radial direction between the valve housing and the closure part.

5. The ball valve according to claim 4, wherein the closure part is arranged by an outer threading in a corresponding inner threading in the valve housing.

6. The ball valve according to claim 1, wherein a nose is arranged on the shaft that transfers a rotary positioning movement of the shaft via an engagement notch in the ball onto the ball.

7. The ball valve according to claim 6, wherein the engagement notch is constructed in such a manner during an engagement of the nose in a position vertical to a direction of flowthrough that a play is present.

8. The ball valve according to claim 1, wherein the ball further comprises an expansion notch that extends from the ball passage conduit toward the chamber on an outside of the ball and by means of which a flowthrough cross section can be reduced for an expansion of a fluid flowing through the ball valve.

9. The ball valve according to claim 8, wherein the expansion notch is designed corresponding up to a bevel of the ball of 65° to 70°.
